(19) United States
(12) Patent Application Publication
(10) Pub. No.: US 2017/0205019 A1
(43) Pub. Date: Jul. 20, 2017

(54) SYSTEM OF ANTICORROSIVE PROTECTION OF METALLIC CONDUCTING PIPES AND/OR FOUNDATION BASED ON HIGH DENSITY POLYETHYLENE

(71) Applicant: Jorge Walter Hirales Fragosa, Guaymas (MX)

(72) Inventor: Jorge Walter Hirales Fragosa, Guaymas (MX)

(21) Appl. No.: 14/705,801

(22) Filed: May 6, 2015

Related U.S. Application Data
(63) Continuation of application No. 13/215,127, filed on Aug. 22, 2011, now abandoned.

(30) Foreign Application Priority Data
Aug. 23, 2010 (MX) 2010009262

(51) Int. Cl. F16L 58/10; B32B 27/12; B32B 27/32; B32B 5/02

(52) U.S. Cl. CPC F16L 58/1018; B32B 5/022; B32B 27/12; B32B 27/32; B32B 2260/021; B32B 2307/412; B32B 2307/752; B32B 2597/00; B32B 2262/0276

(57) ABSTRACT

The present invention relates to a system of the anticorrosive protection of metallic conducting pipes or foundation.

### PRIORITY DATA

This application is a continuation of U.S. patent application Ser. No. 13/215,127, filed Aug. 22, 2011, which claims the benefit of Mexico Patent Application No. MX 2010009262, filed Aug. 23, 2010 under the terms of the Paris Convention.

### FIELD OF THE INVENTION

The present invention relates to a system of the anticorrosive protection of metallic conducting pipes and/or foundation based on high density polyethylene, for their application and use in the chemical and mechanical industry for the protection of metallic conducting pipes and/or foundation, especially for the anticorrosive protection in aerial pipes, submerged under the water or buried, with a minimum preparation of the surface, of easy installation and durability.

### BACKGROUND OF THE INVENTION

The present invention relates to a system of anticorrosive protection of metallic conducting pipes and/or foundation based on high density polyethylene.

The destructive attack of a metal by chemical reaction (dry) or electrochemistry (humid) with its environment is a phenomenon that is know, for example, corrosion. It is a natural process, in which a transformation takes place of the metallic element to a more stable compound, than it is an oxide.

When the corrosion appears in the iron and in alloys, in which the metal turns to an oxide compound, is denominated oxidation.

One of the main causes of the corrosion is the diatomic oxygen, which is dissolved so much in the air, as in the water. It is for that reason that the steel piles and other metallic pipes that are in the call zone of tides and surges present a greater degree of corrosion.

The buried pipe undergoes as much corrosion by polarization as by the presence of oxygen in the water that filters off of the ground surface.

Also, there exists a type of corrosion electrochemistry brought about by some microorganisms able to cause corrosion in the submerged metallic surfaces. Some hydrogen dependent species use dissolved hydrogen of the water in their metabolic processes bringing about a difference of potential of surrounding means. This is known as microbiological corrosion.

The norms that describe to the existing anticorrosive protectors according to the Law of Metrology and Normalization in Mexico are:
NRF-004-PEMEX-2003: Protection with anticorrosive coverings to superficial facilities of ducts.
NRF-026-PEMEX-2001: Protection with anticorrosive coverings for buried and/or submerged pipes.
NRF-053-PEMEX-2005: Systems of anticorrosive protection with coverings for superficial facilities.
NRF-177-PEMEX-2007: System of protection of ascendant duct in the zone of tides and surge (i.e. surf).

At present different systems are known to protect the pipes of the corrosion, but they present deficiencies or disadvantages like for example;
The anticorrosive coatings. Within this classification we can include an infinite number of schemes between which they emphasize the catalyzed epoxy of high solids, modified epoxy, inorganic of zinc, polyurethanes, vinyl epoxy. All of them require of a preparation of the surface to be protected with abrasive commercial degree or white copper which is polluting, levels of controlled humidity and temperature for its correct application. It is not possible to apply them with water present.
The anticorrosive coatings of 100% solids. Its application is extremely simple and it is possible to be placed under the water, even though it requires 7 days to become cured. Nevertheless, if the product operated in immersion, minimum preparation will have to be done of surface to metal near target SSPC-SP10, selecting an abrasive with which a profile of anchorage from 3.0 to 4.0 Mils (76 to 101 microns) is obtained.

The impossibility to apply a corrosion inhibitor under the water makes impossible that the level of cleaning required due to a phenomenon that is known like “corrosion type flash” is obtained. Additionally, completely rigid coatings are unable to adapt to the changes (contraction/expansion) undergone by the metal due to the phenomenon of heat expansion. Thus within quite a short time the oxygen filtration between the covering and the metal occurs, which will bring about the corrosion.
The coatings tri-layer of polypropylene or polyethylene. Although they are effective for the protection against the corrosion, they have the disadvantage of which must be applied in plant, reason why one is used solely in new pipes, and it is not possible to apply it to give preventive maintenance to the pipes already installed.
The coatings based on tapes of polyolefins. Normally they are added with a mechanical protection, consequently work perfectly, nevertheless, the preparation of the surface normally requires of cleaning with abrasive, and it is not possible to be applied in the presence of water humidity.
The coatings of tapes and thermo shrink sleeves. Although the elements that conforms it are used for the anticorrosive protection, and count on mechanical protection, when adhering completely to the substrate it makes vulnerable to the ground efforts in the buried pipe, consequently lose his capacity to protect to the metal against the corrosion.
The coatings of petroleum microcrystalline waxes. They are used in places where the access to the rehabilitation point is difficult since they only require cleaning manual and they can be applied in substrates with temperature of dew. Its efficiency as anticorrosive is excellent, nevertheless, do not tell on a mechanical protection against external means, reason why it is easy that it is exhibited to the substrate.
The coating by sleeved metallic or nonmetallic without annular space. The metallic must be made in stainless steel or CuNi alloys, ASTM B 122, Ni—Cu ASTM B 127 or equivalents and the nonmetallic of reinforced polymer with fiber glass. It is recommended for use under the water.
The metallic coatings or nonmetallic with annular space. They fill up of grout material or epoxy resin. They take the risk of forming air bubbles at the time of the filling. It is recommended for use under the water. Injection ports are due to install and pumping equipment is required.
The coating by anticorrosive linings. They must make of an elastomeric material. Its fastening and closing mechanism to ascendant duct must make with resistant materials to the corrosion. Before the process of installation of the lining, the outer surface due to prepare to white metal the ascendant duct. Apply the material of seal (sticky or epoxy paste) to all the surface of duct to protect according to instructions of the manufacturer, place the lining on duct, align the closing mechanism, place the subjection elements and close, verifying the adjustment of the lining to duct, they do not present folds, blisters and not to be torn in the lining.
The coating by anticorrosive tapes. Normally they are impregnated of microcrystalline waxes of petroleum. They are possible to be placed with water presence. Nevertheless, they lack mechanical protection and they can be torn easily, leaving exposed the metal.

Document MX 277439 of the same applicant, relates to a system of the anticorrosive protection of metallic conducting pipes and/or foundation comprising; a) one first layer consisting of a primary anticorrosive, b) one second layer consisting of a no woven fabric substrate made of synthetic cotton based on polyester, saturated with synthetic mineral fat, c) one third layer consisting of a film based on high density polypropylene, d) one fourth layer consisting of a mechanical cover formed by a geo membrane made of polypropylene, and a fixing mechanism made of security straps of stainless steel.

Nevertheless, in the practice, this system presents a serious problematic one and many disadvantages, in this system hoped that the second layer made of synthetic cotton based on saturated mineral fat polyester to give firmness and to seal the damages of the metallic pipe and to eliminate the air intake or aerobic bacteria to the protected metallic surface, was been 100% effective, this is not obtained to the 100% because the not woven fabric includes synthetic cotton that is degraded in a small proportion by the air intake and the bacteria. Also it was hoped that the third layer made of high density polypropylene (polymeric chain with three carbon atoms) was been effective to the 100% to work like gasket of heat expansion, mechanical protection and of not allowing the passage of oxygen, but nevertheless this does not happen to the 100%, over time and with the changes of temperature, especially with high temperatures it has been observed that this layer is deteriorated quickly and finally it is broken being exhibited the metallic pipe to all these factors and without protection. Finally the fourth covered layer of mechanical protection formed by a geomembrane made of polypropylene (polymeric chain with three carbon atoms) is not effective either to the 100%, this because it is broken by the effects wind, by the effects of the waves and the blows received by the boats in the case of submerged or semi-submerged metallic pipes.

In order to solve all this problematic and inconvenient it hopes that when using homopolymers with a greater number of carbon atoms in the polymeric chain (more than three carbon atoms) either crosslinked, branched and/or grafted, or using crosslinked, grafted or branched copolymers, all this problematic would be solved, which in the practice was not possible.

Nevertheless, to solve all these problems and disadvantages a new system is developed in which surprising in the second layer is used a not woven fabric substrate made exclusively of polyester saturated of mineral fat to give firmness and to seal the damages of the metallic pipe and to eliminate the air intake or aerobic bacteria to the protected metallic surface. The third layer surprising is made of polyethylene of low linear density, this layer supports the changes of temperature (low and high temperatures) avoiding with this that the layer is deteriorated quickly and finally it is broken, being the metallic pipe exhibited to all the environmental factors and without protection. Finally the fourth layer of mechanical protection forms with a geomembrane made of high density polyethylene instead of polypropylene, avoiding surprising to break by the wind effects, by the effects of the waves and the blows received by the boats in the case of submerged or semi-submerged metallic pipes.

None of mentioned documents previously solves all this problematic and inconvenient, reason why the system of anticorrosive protection of the present invention is new and inventive because this system solves all this problematic and inconvenient, in addition that has advantages with respect to other systems of protection.

### BRIEF DESCRIPTION OF THE FIGURES

FIG. 1, shows the correct and incorrect way to place rolls of corrosion protective covering for its application, as well as the sense of the turn of the same.

FIG. 2, shows the correct and incorrect way to place the cover of mechanical protection, as well as the position of overlaps of the same.

FIG. 3, shows the correct way and incorrect to realize it overlaps between 2 covers in vertical pipes.

FIG. 4, shows a metallic clasp for the fastening mechanism.

FIG. 5, shows a nonmetallic clasp to the fastening mechanism.

FIGS. 6 to 12 represent piles where the polypropylene like cover of mechanical protection of the system was used (priori art), in which the deterioration of the cover leaving exhibited the piles to the corrosion can be appreciated.

FIGS. 13 to 17 represent piles where high density polyethylene was used like cover of mechanical protection of the system of the present invention, in which it is possible to be appreciated that there is no deterioration of the cover.

### DESCRIPTION OF THE INVENTION

The present invention relates to a system of the anticorrosive protection of metallic conducting pipes and/or foundation based on high density polyethylene, for their application and use in the chemical and mechanical industry for the protection of metallic conducting pipes and/or foundation, especially for the anticorrosive protection in aerial pipes, submerged under the water or buried, with a minimum preparation of the surface, of easy installation and durability.

The system of the anticorrosive protection of metallic conducting and/or foundation of the present invention comprising:

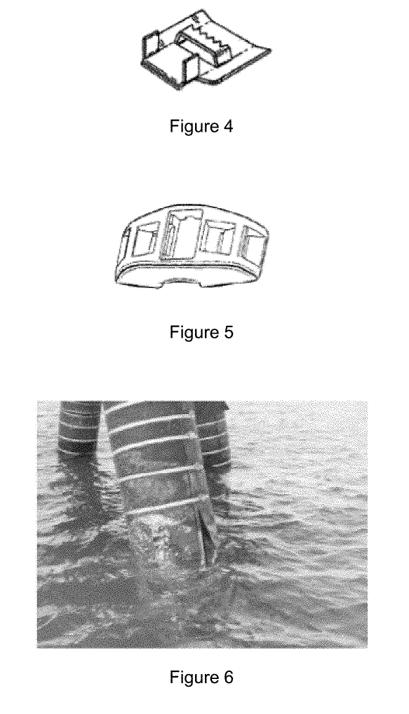

a) One first layer that consists of a synthetic mineral fat formed by a primary hydrophobic anticorrosive, with petrolate (plasticizing paraffinic oil with properties similar to those of Sunpar 2280, that structurally has a predominance of saturated ring and paraffinic side chains, density of 0.899 to 15° C., viscosity of 475 cst to 40° C. and 31 to 100° C., aniline point to 122° C., 1.494 refracting index 20-D, VGC of 0.809, composition type of coal C_{A} 5%, C_{N} 28% and CP 67%; combined with petroleum wax made mainly of a normal paraffin mixture of linear chain and grafted chain of isoparaffins, with a point of solidification between 68-81° C., contained in oil of 5% of the weight; kinematic viscosity of 16-20.5 cst, at a temperature of 100° C., mm2/s; density of 806 kg/m3 to 85° C. and 862 kg/m3 to 15° C.), talcum with 3MgO-4SiO₂—H₂O, dispersing agent based on R—NH—(CH₂)₃—NH₂ and a biocide with 4-chlorine-3-metilphenol. This layer is used to move the humidity of the metallic surface, to fill up small irregularities in the surface and like sealant of the oxidants being formed a stratification of oxides or magnetite. This primary coating is resistant to the chemicals, impermeable to the water and is not dried or hardens;
b) The second layer is an anticorrosive tape consisting of a no woven fabric substrate made with polyester, with a weight of 2.75-3.00 ounces by square yard (100 grams by square meter). This tape is saturated with the primary anticorrosive of the first layer. It has a resistance to the tension of 8 N/mm, mass of 1.44 kg/m², without volatile organic compounds, specific gravity superior to 1.0 and an aqueous steam permeability of 0.00012 kg/m²/24 hrs. This tape is not polymerized and oxidized and their properties of no hardening allow him to absorb so much the vibrations as the movements of the substrate. This second layer serves to give firmness and to seal the damages suffered by the metallic pipe. Also it eliminates the air intake or aerobic bacteria to the protected metallic surface. The tape is applied in situ. The tape must be surrounded in spiral form on the pipe using overlaps minimum of 25 millimeters in all the applications. When additional protection is required overlaps is increased until 55%, and so a double thickness of tape will be obtained, eliminating the air intake or aerobic bacteria to the surface of the structure. The tape can be applied longitudinally when the space is too much restricted or bordered to make the application in the form of spiral;
c) Third layer, formed by a film made with low linear density polyethylene, with an approximated thickness of 20 microns (0.8 thousands), odorless, colorless, transparent, water insoluble, with a point of melting of 112° C., flash point of 343° C., density of 915-927 kg/m². This layer is used to work like meeting of heat expansion, between the steel and previous layers, against the cover of mechanical protection. In addition, when not allowing the oxygen passage, it forms one third barrier against the corrosion;
c) Fourth layer: Cover of mechanical protection made of geomembrane of high density polyethylene, produced of virgin polyethylene resin that will give the flexibility him necessary to act like membrane. It contains approximately 97.5% polyethylene, 2.5% black coal and signs of antioxidants and heat stabilizers. It is resistant to ultraviolet rays and their use as outdoors resistant, resistant to chemical agents and counts on dimensional stability. The size of each sheet of cover will be cut custom-made, following the requirements of application, preferably with length no greater than 6 meters. To it being a dielectric material assures to us that any electrochemistry corrosion can de produced, since it is not going to let pass the electricity. It fulfills specified in standard GRI-GM13 of the Institute of Geosynthetic Investigation, denominated “Methods of Test, Properties of Tests and Frequency of tests for smooth and texturized geomembrane, made of high density polyethylene” and
e) Fastening mechanism: Straps of security made in stainless material (i.e. Aluminum 5052, Stainless steel 316, Nylon 6.6, 11 Nylon or Acetal) with pressure clasps (to see FIG. 4 and FIG. 5), which serve to hold and to seal the layers before mentioned. These straps are placed with a separation of 25 to 50 centimeters throughout the protected surface, following the conditions of operation of the metallic pipe. When the metallic pipe is submerged in water with brief currents recommends a separation between straps of 30 centimeters. When one is submerged exposed to currents and/or tides cheers and hard surges a separation between straps of 25 centimeters is recommended, as it is the case of piles of wharves none protected with breakwater. When the metallic pipe is outdoors recommends a separation between straps of 50 centimeters. In the case of buried pipes a separation between straps of 25 centimeters is recommended.

In one first embodiment the system of the anticorrosive protection of metallic conducting and/or foundation of the present invention comprising:

a) One first layer that consists of a synthetic mineral fat formed by a primary hydrophobic anticorrosive, with petrolate (plasticizing paraffinic oil combined with compound petroleum wax mainly made of a normal paraffin mixture of linear chains and grafted chain of isoparaffins), talcum with 3MgO-4SiO₂—H₂O, dispersing agent based on R—NH—(CH₂)₃—NH₂ and a biocide with 4-chlorine-3-metilphenol;
b) The second layer is an anticorrosive tape consisting of a no woven fabric substrate made with polyester, with a weight of 2.75-3.00 ounces by square yard (100 grams by square meter), saturated with the primary anticorrosive of the first layer, until obtaining a thickness of 1.3 millimeters, resistance to the tension of 8 N/m, mass of 1.444 kg/m², without volatile organic compounds, specific gravity superior to 1.0 and an aqueous steam permeability of 0.00012 kg/m²/24 hrs;
c) A third layer, one film made with low linear density polyethylene, with an approximated thickness of 20 microns (0.8 mm), odorless, colorless, transparent, water insoluble, with a point of melting of 112° C., flash point of 343° C., density of 915 up to 927 kg/m²;
d) one fourth layer, a cover of mechanical protection formed by geomembrane made of high density polyethylene, with an approximated content of 97.5% of high density polyethylene, 2.5% of black coal and signs of antioxidant and heat stabilizers, and
e) A fastening mechanism of straps security made in stainless material (aluminum 5052, stainless steel 316, nylon 6.6, 11 nylon or acetal) with pressure clasps.

In one second embodiment the no woven fabric substrate made of polyester is used in the second layer of the system of the anticorrosive protection of metallic pipes of the present invention.

In one third embodiment the film of low linear density polyethylene is used in the third layer of the system of anticorrosive protection for metallic pipes of the present invention.

In fourth embodiment the geomembrane of high density polyethylene is used in the fourth layer of the system of the anticorrosive protection of metallic pipes of the present invention.

The procedure to correctly apply to the system of the anticorrosive protection of metallic conducting pipes and/or foundation based on high density polyethylene of the present invention comprising the following steps:

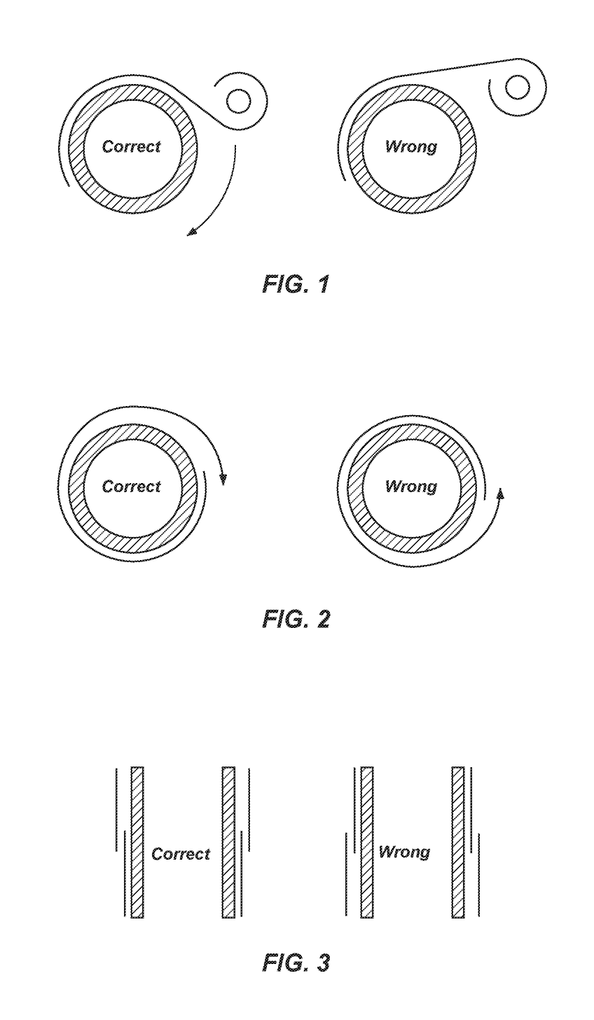

a) Preparation of surface: The metallic surface can be humid or totally submerged in water. To clean the metallic surface to eliminate all the oxide badly adhered, painting and crud by average manuals according to specification SSPC-SP-2 of the Society of Protective coatings (Society for Protecting Coatings), denominated “Cleaning Manual”, and to eliminate the excesses of weld, and sharp tip of the surface;
b) To apply a first layer, consisting of primary covering, on the metallic surface, using the hand, broaches, glove, rag or roller. To apply a thin uniform layer on the total surface being protected, considering a yield in the use of the material from 1.5 to 2.5 m²/kg. It is recommended not to exceed a length greater to 7 meters,
c) Application on the primary anticorrosive of an anticorrosive polyester nonwoven tape. This tape must be surrounded in spiral form on the pipe using overlaps minimum of 25 millimeters in all the applications. When additional protection is required overlaps is increased until 55%, and so a double thickness of tape will be obtained. The tape can be applied longitudinally when the space is too much restricted or bordered to make the application in the form of spiral. It firmly maintains the tape against the beginning point, make pressure against the surface. It unrolls the tape at the same sense of the surrounding turn on the pipe (to see FIG. 1), maintaining the roll near the surface. The tape roll does not separate too much then this one will tend to bend and to leave emptiness in the surface at the time of being coiled. The tape is applied better coiling it near the pipe and giving the suitable tension him. It is necessary to apply sufficient tension to give continuous adhesion, without stretching the tape. During the application process, it presses all the cuffs and bubbles that could form to eliminate any water or air inside. It maintains overlaps minimum of 150 millimeters when the final part of a roll with the beginning of a new roll is superposed. It overlaps must be realized in the part superior of the pipe. To the completion of each tape roll, to smooth the overlap with the hand in the direction of the spiral to assure the seal overlaps. In the vertical applications it initiates at bottom and it comes upwards creating overlaps type fabric;
d) Application of film of low linear density polyethylene. This film must be surrounded in spiral form on the pipe using overlaps minimum of 25 millimeters in all the applications. When additional protection is required overlaps is increased until 55%, and so a double thickness of film will be obtained. The film can be applied longitudinally when the space is too much restricted or bordered to make the application in the form of spiral. It firmly maintains to the film against the beginning point make pressure against the surface. It unrolls the film in the same sense of the surrounding turn on the pipe (to see FIG. 1), maintaining the roll near the surface. The film reel does not separate too much then this one will tend to bend and to leave emptiness in the surface at the time of being coiled. The film is applied better coiling it near the pipe and giving the suitable tension him. It is necessary to apply sufficient tension to give continuous adhesion, without stretching the film. During the application process, presses it all the cuffs and bubbles that could form to eliminate any water or air inside. It maintains overlaps minimum of 150 millimeters when the end part of the roll is superposed with the beginning of a new roll. It overlaps must be realized in the part superior of the pipe. To the completion of each film roll, to smooth the overlap with the hand in the direction of the spiral to assure the seal overlaps. In the vertical applications it initiates at bottom and it comes upwards creating overlaps type fabric;
e) Application of a geomembrane cover. The sections that were cut in accordance with the cover of mechanical protection of high density polyethylene are positioned around the pipe to protect, leaving overlaps in the longitudinal unions of at least 10.00 centimeters. In order to assure the handling manual to each section, it is recommended that the length of the same is not greater to 7 meters. The external face of overlaps longitudinal will have to point downwards in the pipe that is in horizontal position, staying to a flank of the same, to make sure that at the time of covering the pipe they do not penetrate strange materials to the system, or in the aerial pipe, that does not penetrate rainwater or another material stranger to the system (to see FIG. 2). In the case of the pipe that is in vertical position, the external face of overlaps longitudinal will have to point in opposition sense to the direction of the swell and/or predominant wind in the zone to reduce the effort of the fastening mechanism. In it overlaps between two sections of cover will be due to take care of, in the case of the vertical pipe, that the section superior is superposed on the section inferior (to see FIG. 3). In the case of the horizontal pipe it overlaps between sections is indistinct, and
f) Application of fastening mechanism: the cover of mechanical protection by means of straps or straps of stainless material assured by pressure clasps. The straps are placed with a separation among them of 25 to 50 centimeters, with a pressure of 60 pounds. The environmental conditions will determine the type of material used in the fastening mechanism as well as the separation between the same. When the metallic pipe is submerged in water with brief currents recommends a separation between straps of 30 centimeters. When one is submerged exposed to current and/or tides cheers and hard surges a separation between straps of 25 centimeters is recommended, as it is the case of piles of wharves none protected with breakwater. When the metallic pipe is outdoors recommends a separation between straps non greater to 50 centimeters. In the case of buried pipes a separation between straps of 25 centimeters is recommended. In the closings of the protection, a strap to a distance non greater to 50 millimeters of the closing will be due to place. Additionally, a strap will be due to place on overlaps cross-sectional in the case of the union of two sections.

It is possible to mention that in steps b) and d) of the procedure, the application of the layers that compose the system of the anticorrosive protection, is with a length of 1 meter greater than the length of the cover, since with this we avoided the contamination by dust, water and air to the layer of bandage of synthetic material.

### Benefits

1) The system of the anticorrosive protection is easy to install and it does not require of machinery or complicated equipment.

2) The application of the system of anticorrosive protection is in situ, allowing the preventive maintenance of metallic conducting pipes and/or foundation, and in this way to extend the life utility of the same.

3) The application or installation of the system of the anticorrosive protection is possible to apply it as much to aerial pipe, as buried, tides and surges or in submarine zone; which is an advantage against the rest of the present state of the art.

4) Once applied the system of the anticorrosive protection, the wearing and chemical or electrochemical damage to the metallic pipe produced by the corrosion are stopped.

5) The metallic pipes, indifferently to be conduction or foundations, do not need to leave operation during the installation of the protection system.

6) The system of anticorrosive protection, is able to adapt for the purposes of the physical phenomenon denominated “heat expansion”, when including a layer that works like expansion gasket, which makes unique.

7) The product combination and the improvement in the method of installation them, optimize the capacity of the system to protect the metallic pipes mechanically and against the corrosion.

8) This protector non cause damage to environment, since he does not have volatile organic compounds, and it is not corrosive.

9) The application of this protector helps to the cathodic protection of the metallic pipes; since the materials that conform it are dielectric, mainly the cover of high density polyethylene, which have the same dielectric strength or superior to the 30 kv and a resistance of isolation of 125 Gohms. In the cases in that the totality of the length of pipes of laying of foundations in the presence of water of sea has been protected, with this system of the anticorrosive protection, the obtained measurements to detect the galvanic action oscillates of 1-3 Amp CD in the case of the current and of 0.85-1.1 V in the tension, which are within the allowed ranks of security. This is an advantage against the other existing anticorrosive systems of the protection.

10) With the substitution of the material of the cover of mechanical protection of polypropylene to high density polyethylene the resistance to the impact in more than 13% is increased against the previous system. From the same way, 26.31% more of resistance to the puncture is obtained.

### COMPARATIVE EXAMPLE

The following example has the purpose of illustrating the present invention, not to limit it, and show the results obtained in the analysis of behavior of the used covers of protection in the system of the present invention, that are handled commercially with 100 marks S and S 100+.

a) Model S100-polypropylene, this 5100 cover was developed and includes a cover of mechanical protection with polypropylene, used in Puerto Libertad, Sonora in 2002.

b) Model S100+-high density polyethylene, this S100+ cover to request, was developed like material substitute of polypropylene, in the first stage of protection in the wharf of Port San Carlos, South Baja Calif. in 2002.

### Preliminary Results

From the inspection two years later, realized at the end of 2004, the following thing is determined:

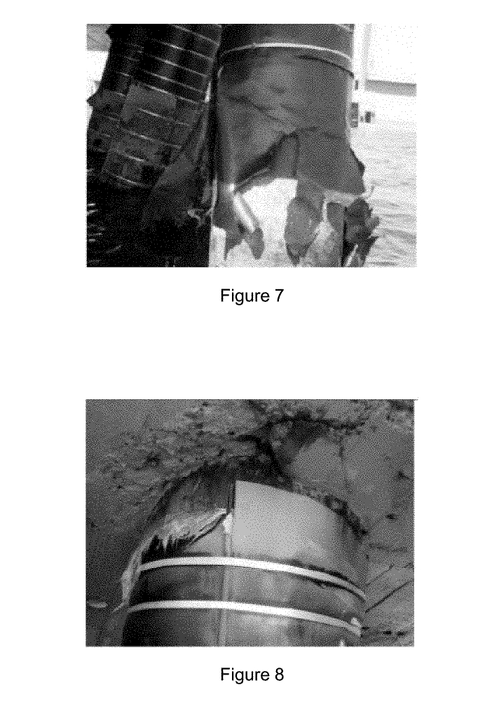

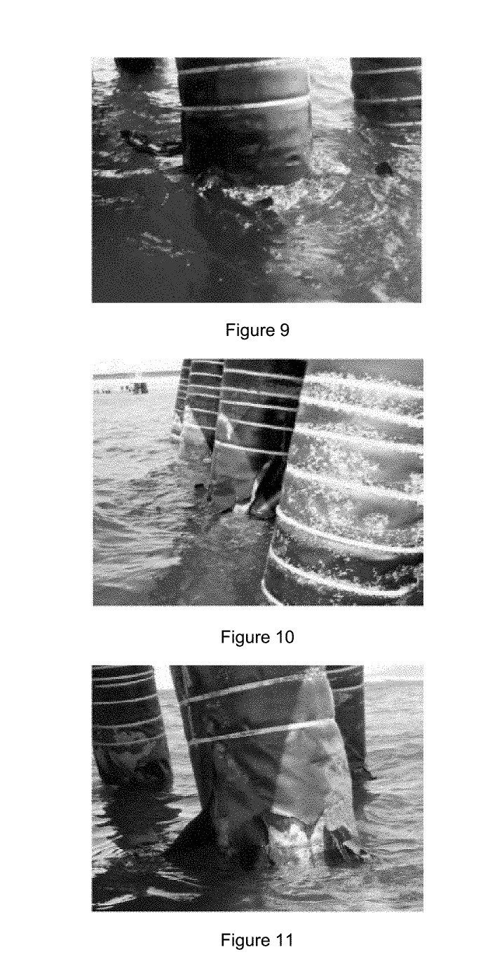

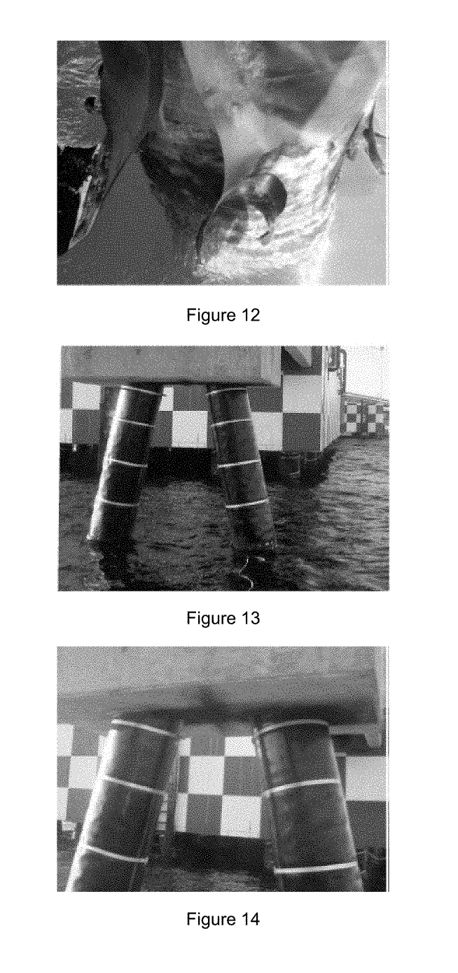

a) Pipe of foundation (piles of steel to coal) that was protected with the 5100 system having used polypropylene as mechanical protection did not support the impact of boat (shallow-draft vessels), regularly used during the mooring processes/disarmament of ships. (see FIGS. 6-12)

b) Also, a wearing down in the cover of mechanical protection of polypropylene due to the permanent contact with the marine saline environment, and the inclemency of the time was detected derived from hurricanes or cyclones. (see FIGS. 6-12)

c) On the other hand, the pipes protected with the S100+ system, that uses the high density polyethylene like mechanical protection, showed an optimal performance in similar environmental conditions.

d) Due to the previous thing it was chosen to use the S100+ model only in the protection of the second section in both wharves, realized in 2005.

### Results

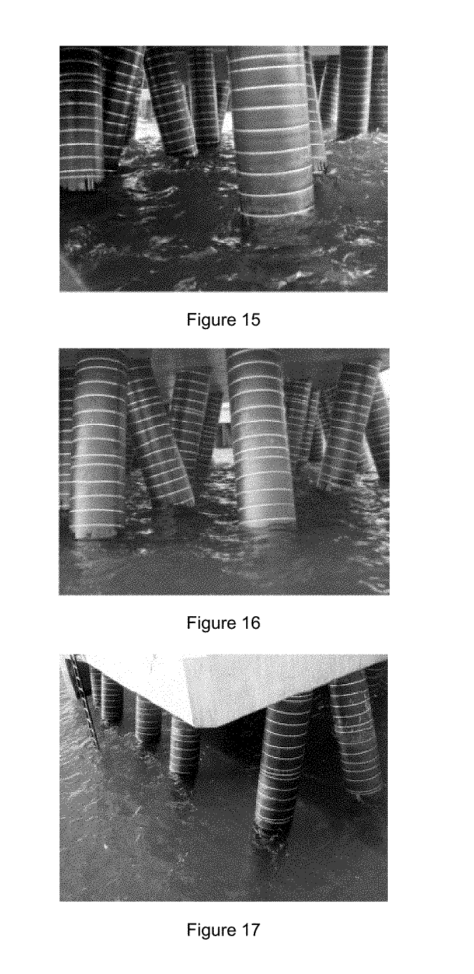

During the inspection realized by the supervisor to the facilities of Port San Blas in November of 2008 it demonstrates that the piles protected from the 2002 with the system of the anticorrosive protection of the present invention using high density polyethylene as mechanical protection maintains its integrity and continues protecting. (see FIGS. 13-17).

The facilities of Port Libertad were inspected in April of 2009 by the supervisor, this inspection could indeed determine that those pipes protected with the system of anticorrosive protection of the present invention using high density polyethylene as mechanical protection maintains its integrity and continues protecting. On the other hand, the pipes that conserved the polypropylene cover maintain the waited deterioration. (see FIGS. 13-17)

### CONCLUSIONS

1) According to a study realized by FDT Mexican SA of CV on the behavior in field of the mechanical protection based on polypropylene and polyethylene of high density (HDPE), developed for more than seven years was verified that the performance of the high density polyethylene in conditions of an aggressive saline marine environment, it is much superior to polypropylene.

2) Derivative of the denominated study “Resistance to the Impact and the Traction of Compound Materials Plastic-Wood” made of M. E. Solis and J. H. Lisperguer. Department of Chemistry, Faculty of Sciences, University of Bio-Bio, Avenue Collao No. 1202, Concepción-Chile determined that the resistance to the impact measured in kg/m² of the high density polyethylene is of 10 and the one of polypropylene it is of 8.8. That is to say, using high density polyethylene replacing polypropylene the resistance to the impact is increased in 13.63%.

3) On the other hand, according to technical card that offers the company Layfield, manufacturer of geomembranes of polypropylene and of polyethylene of high density, is forceful superiority of polyethylene of high density on polypropylene with regard to resistance to puncture (ASTM-D-4833), since the HDPE resists 480N against 380 N that resists polypropylene, both with a thickness of 60 thousandth. That is to say, using HDPE 26.31% more resistance to the puncture is obtained, which is extremely important mainly in wharves where the tubes of foundation (piles) continuously take hits or collisions of shallow-draft vessels (boats) used normally during the operations of mooring and unties of boats, as well as maintenance workings.

It is pointed out that in relation to this date; the best method known by the applicant to carry out the mentioned invention is the one that is clear from the present description of the invention.

What is claimed is:

1. A system for anticorrosive protection of metallic conducting pipes or foundation comprising:
a) a first layer of a synthetic mineral fat formed by a primary hydrophobic anticorrosive, with petrolate (plasticizing paraffinic oil combined with compound petroleum wax substantially made of a normal paraffin mixture of linear chains and grafted chain of isoparaffins), talcum with 3MgO-4SiO₂—H₂O, a dispersing agent based on R—NH—(CH₂)₃—NH₂ and a biocide with 4-chlorine-3-metilphenol;
b) a second layer comprising an anticorrosive tape having a non-woven fabric substrate made with a polyester, with a weight of 2.75-3.00 ounces by square yard (100 grams by square meter), and saturated with the primary anticorrosive of the first layer, until a the following characteristics are obtained without volatile organic compounds: a thickness of 1.3 millimeters, a tension resistance of 8 N/m, mass of 1.444 kg/m², a specific gravity superior to 1.0 and an aqueous steam permeability of 0.00012 kg/m²/24 hrs;
c) a third layer having one film made with low linear density polyethylene, with an approximated thickness of 20 microns (0.8 mm), and being odorless, colorless, transparent, and water insoluble, and having a melting point of 112° C., a flash point of 343° C., and density of from 915 up to 927 kg/m²;
d) a fourth layer including a cover of mechanical protection formed by a geomembrane made of high density polyethylene, with an approximated content of 97.5% of polyethylene of high density, 2.5% of black coal and signs of antioxidant and heat stabilizers; and
e) a fastening mechanism of security straps made in stainless material with pressure clasps.

2. A system of anticorrosive protection of metallic conducting pipes or foundation of claim 1, wherein the first layer is used to move the humidity of the metallic surface, to fill up small irregularities in the surface and like sealant of the oxidants being formed a stratification of oxides or magnetite; this primary covering is resistant to chemicals, impermeable to water and does not dry or harden.

3. A system of anticorrosive protection of metallic conducting pipes or foundation of claim 1, wherein the second layer serves to give firmness and to seal damage suffered by the metallic pipe; and also eliminate intake of air or aerobic bacteria to the protected metallic surface.

4. A system of anticorrosive protection of metallic conducting pipes or foundation of claim 1, wherein the third layer is used to function as a gasket of heat expansion, between the previous steel and layers, and against the cover of mechanical protection; and further when not allowing passage of oxygen, the layer forms one third of the barrier against the corrosion.

5. A system of anticorrosive protection of metallic conducting pipes or foundation of claim 1, wherein the fourth layer, comprises custom made sections with non major lengths of 7 meters.

6. A system of anticorrosive protection of metallic conducting pipes or foundation of claim 1, wherein the security straps serve to hold and to seal the layers, and are placed with a separation of 25 to 50 centimeters throughout the protected surface.

7. Use of non-woven fabric substrate made of polyester in one second layer, in a system of anticorrosive protection for metallic pipes of claim 1.

8. Use of a film of low linear density polyethylene in one third layer, in a system of anticorrosive protection of metallic pipes of claim 1.

9. Use of a geomembrane of high density polyethylene in one fourth layer, in a system of anticorrosive protection of metallic pipes of claim 1.
